(19) United States
(12) Patent Application Publication
(10) Pub. No.: US 2013/0024767 A1
(43) Pub. Date: Jan. 24, 2013

(54) E-BOOK TERMINAL AND METHOD FOR SWITCHING A SCREEN

(71) Applicant: Hyeong-Min Nam, Suwon-si (KR)

(72) Inventor: Hyeong-Min Nam, Suwon-si (KR)

(73) Assignee: Samsung Electronics Co., Ltd., Suwon-si (KR)

(21) Appl. No.: 13/556,033

(22) Filed: Jul. 23, 2012

(30) Foreign Application Priority Data
Jul. 22, 2011 (KR) 10-2011-0073193

(51) Int. Cl. G06F 17/00; G06F 3/041

(52) U.S. Cl. 715/251

(57) ABSTRACT

According to one embodiment, an electronic book (E-book) terminal comprising a touch screen and configured to switch a screen corresponding to content includes a display for displaying a user input area set to support an application for screen switching, and display a screen where page switching is performed depending on a user's manipulation made in the user input area, an input recognizer for recognizing an action command corresponding to the manipulation made on the touch screen in the user input area displayed on the display, and a controller for detecting a start page, a moving direction, and a moving distance based on the action command recognized by the input recognizer. The controller configured to display a page-switching screen from the start page to a target page determined based on the moving direction and the moving distance, and displaying the target page upon completion of moving of the page.

### CROSS-REFERENCE TO RELATED APPLICATION(S) AND CLAIM OF PRIORITY

The present application is related to and claims the benefit under 35 U.S.C. §119(a) of a Korean Patent Application filed in the Korean Intellectual Property Office on Jul. 22, 2011 and assigned Serial No. 10-2011-0073193, the entire disclosure of which is incorporated herein by reference.

### TECHNICAL FIELD OF THE INVENTION

The present invention relates generally to electronic book (E-book) terminals, and more particularly, to an e-book terminal and method for switching a screen corresponding to a plurality of pages.

### BACKGROUND OF THE INVENTION

Traditionally, paper has been used as a medium for recording and conveying a variety of information. However, when used as a recording medium, paper increases in volume and weight in proportion to the amount of information recorded. In addition, there exists relatively few efficient means of preserving and storing paper.

Thanks to the development of the Internet and digital technology, E-books have been developed as alternative recording medium for replacing paper. The term ‘E-book’ as used herein may refer to electronically stored books that replace paper books and are published by storing texts written in electronic documents in electronic recording media. In other words, E-books may generally include publications produced by processing and storing book content as digital information. E-books are called many different names such as E-texts, online books, and file books.

E-books are relatively easy to carry. In addition, compared to paper books, E-books are simpler to distribute lower in inventory burden, may provide a variety of content, and efficiently store and manage the content. Due to these and other advantages, the market for E-books is expected to steadily expand.

However, users, who are familiar with paper books, tend to remain unfamiliar with E-books.

Therefore, in order to activate and expand the E-book market, ongoing research should be conducted to reflect the advantages of E-books.

### SUMMARY OF THE INVENTION

To address the above-discussed deficiencies of the prior art, it is a primary object to provide an E-book terminal equipped with a touch screen and supporting a user interface for switching pages displayed on a screen, and a method for switching the display.

Another embodiment of the present disclosure provides an E-book terminal equipped with a touch screen and a user interface for supporting convenient moving between pages displayed on a screen, and a method for switching the display.

Another embodiment of the present disclosure provides an E-book terminal equipped with a touch screen configured to display content depending on its priority from among a plurality of content composed in a plurality of pages, and a method for switching the display.

In accordance with one embodiment of the present disclosure, an electronic book (E-book) terminal that is equipped with a touch screen and configured to switch a displayed content including a plurality of pages. The E-book terminal includes a display that is configured to display a user input area set to support an application for screen switching, and display a screen where page switching is performed depending on a user's manipulation made in the user input area, an input recognizer that is configured to recognize an action command corresponding to a user's manipulation made on the touch screen in the user input area displayed on the display, and a controller configured to detect a start page, a moving direction, and a moving distance based on the action command recognized by the input recognizer, displaying, on the display, a page-switching screen from the start page to a target page determined based on the moving direction and the moving distance, and display the target page upon completion of moving of the page.

In accordance with another aspect of the present disclosure, a method for switching a screen corresponding to content including a plurality of pages in an electronic book (E-book) terminal equipped with a touch screen includes displaying a user input area set to support an application for screen switching, recognizing an action command corresponding to a user's manipulation made on the touch screen in the displayed user input area, detecting a start page, a moving direction, and a moving distance based on the recognized action command, and displaying a page-switching screen from the start page to a target page determined based on the moving direction and the moving distance, and displaying the target page upon completion of moving from the start page to the target page.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example E-book terminal according to an embodiment of the present disclosure;

FIG. 2 illustrates an example user input area in an E-book terminal according to an embodiment of the present disclosure;

FIG. 3 illustrates another example user input area in an E-book terminal according to another embodiment of the present disclosure;

FIG. 4 illustrates another example user input area in an E-book terminal according to another embodiment of the present disclosure;

FIG. 5 illustrates an example page-switching screen according to an embodiment of the present disclosure;

FIG. 6 illustrates an example method of switching a screen according to an embodiment of the present disclosure;

FIGS. 7A to 7C illustrate another example method of inputting an action command according to an embodiment of the present disclosure;

FIG. 8 illustrates another example method of switching a screen according to another embodiment of the present disclosure;

FIGS. 9A to 9C illustrates an example method of selecting an option according to an embodiment of the present disclosure;

FIG. 10 illustrates an example E-book terminal according to another embodiment of the present disclosure;

FIG. 11 illustrates an example method of switching a screen according to another embodiment of the present disclosure;

FIGS. 12A and 12B illustrate an example method of selecting an option according to another embodiment of the present disclosure; and

FIGS. 13A and 13B illustrate an example method of inputting an action command according to another embodiment of the present disclosure.

Throughout the drawings, the same drawing reference numerals will be understood to refer to the same elements, features and structures.

### DETAILED DESCRIPTION OF THE INVENTION

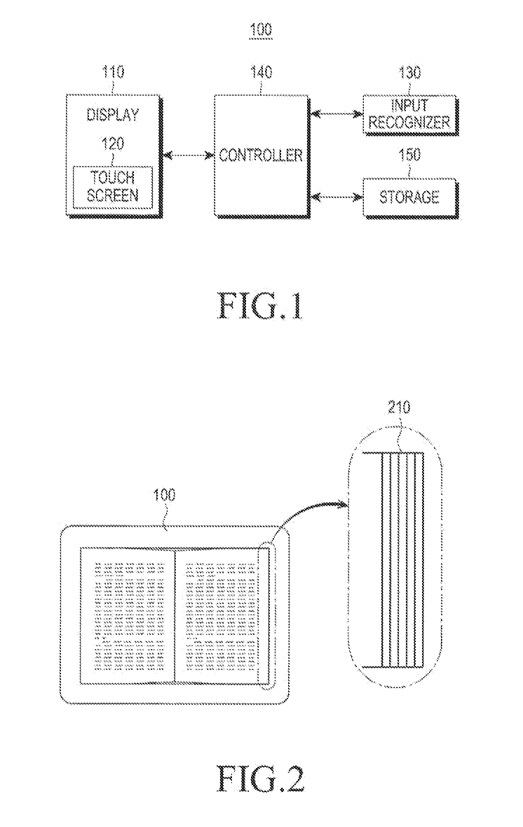

FIGS. 1 through 13B, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged E-book terminals.

Operating principles of an E-book terminal and a screen switching method according to an embodiment of the present disclosure will be described in detail with reference to the accompanying drawings. The following detailed description made with reference to the accompanying drawings is of the best currently contemplated modes of carrying out exemplary embodiments of the present disclosure. Therefore, the present disclosure should not be limited to the following drawings and description.

In the following description of the present disclosure, descriptions of well-known functions and constructions are omitted for clarity and conciseness. In addition, specific details such as detailed configuration and components are merely provided to assist the overall understanding of exemplary embodiments of the present disclosure. Therefore, it should be apparent to those skilled in the art that various changes and modifications of the embodiments described herein can be made without departing from the scope and spirit of the disclosure.

In a below-described embodiment of the present disclosure, an E-book terminal equipped with a touch screen that is configured to switch a screen corresponding to content including a plurality of pages will be described in detail. In another embodiment of the present disclosure, an E-book terminal that is configured to switch a screen corresponding to content including a plurality of pages depending on the movement of a user's finger will be described in detail.

As for an E-book terminal to which an embodiment of the present disclosure is applicable, its type does not matter as long as the E-book terminal is one equipped with a touch screen and/or a camera and capable of switching a displayed screen corresponding to content. For example, the E-book terminal may include mobile communication terminals capable of performing voice and/or video calls, MPEG Audio Layer-3 (MP3) players, Portable Multimedia Players (PMPs), handheld game consoles, Personal Digital Assistants (PDAs), and portable computers (e.g., tablet PCs, notebook computers, and netbook computers).

An embodiment of the present disclosure will be described in detail below with reference to the accompanying drawings.

FIG. 1 illustrates an example E-book terminal according to an embodiment of the present disclosure.

Referring to FIG. 1, an E-book terminal 100 includes a display 110, a touch screen 120, an input recognizer 130, a controller 140, and a storage 150.

The display 110 displays the output of an application(s). In other words, the display 110 displays a user input area 210 (FIG. 2) set up to support an application for screen switching. For example, the display 110 may display the user input area 210 on one side of the display 110 as shown in FIG. 2, or may display a user input area 320, part of which overlaps a page section displayed on the display 110 as shown in FIG. 3.

The display 110 displays content where page switching is performed depending on a user's manipulation made in the user input area 210. The display 110 displays at least one of an index, summary information, headline information, and a representative picture corresponding to each page being switched. If it switches a plurality of pages when displaying a page-switching screen, the display 110 displays the page that is selected under control of the controller 140. If there is multiple content, the display 110 displays only the content that meets the priority from among the multiple content, under control of the controller 140.

The display 110 displays user-selectable options in the user input area 210 under control of the controller 140. The display 110 may vertically display the user input area 210 in the position where a user's press action occurred.

The display 110 displays the operation information and resulting information generated during operation of the E-book terminal 100. For example, the display 110 may display the data stored in the storage 150.

The display 110 may display the status of the E-book terminal 100, such as a battery level, a date, and a time. The display 110 may be any type that displays pages of E-books. For example, the display 110 maybe implemented by a Liquid Crystal Display (LCD), a Thin Film Transistor-Liquid Crystal Display (TFT-LCD), an Organic Light-Emitting Diode (OLED), a flexible display, and a three-dimensional (3D) display.

The touch screen 120 function as a user interface for receiving various input commands from the user. In other words, the touch screen 120 receives action commands for screen switching using an input means. The user manipulates or issues action commands on the touch screen 120 in the user input area 210 using the input means. The touch screen 120 functions in conjunction with the display 110. The input means may include a user's fingertip (s) or a stylus pen.

The input recognizer 130 recognizes action commands corresponding to user's manipulations on the touch screen 120 in the user input area 210 displayed on the display 110. The input recognizer 130 may recognize touch actions using a capacitive characteristic, a resistive characteristic, a surface ultrasound characteristic, and/or an infrared characteristic, and output information about the touch actions to the controller 140.

The input recognizer 130 recognizes a press action with a specified pressure in a specified point on the touch screen 120, and recognizes a page moving start command corresponding to the recognition result. The input recognizer 130 recognizes a drag action made by a predetermined moving distance with a specified pressure starting from a point where the press action occurred on the touch screen 120, and recognizes a page moving command corresponding to the recognition result. The input recognizer 130 recognizes a removal of the press action with a specified pressure in an arbitrary position during the drag action on the touch screen 120, and recognizes a moving stop command corresponding to the recognition result.

The input recognizer 130 recognizes an action in which a press action with a specified pressure is maintained in an arbitrary position during the drag action for a specified time, and recognizes an option search command corresponding to the recognition result. The specified time represents a time in which the user should press (or touch) the touch screen 120 to select an option, and may be set by the user or a manager of the E-book terminal 100.

The input recognizer 130 recognizes an option selection command by recognizing a drag action made upward or downward after the option search command is recognized.

The input recognizer 130 recognizes moving on the touch screen 120 and recognizes a multi-page moving command corresponding to the recognition results.

The input recognizer 130 provides, to the controller 140, an action command including at least one of the recognized moving start command, page moving command, moving stop command, option search command, and/or option selection command.

The controller 140 controls components of the E-book terminal 100 to switch a screen corresponding to content including multiple pages. Specifically, the controller 140 sets up the user input area 210 to receive an action command for screen switching from the user.

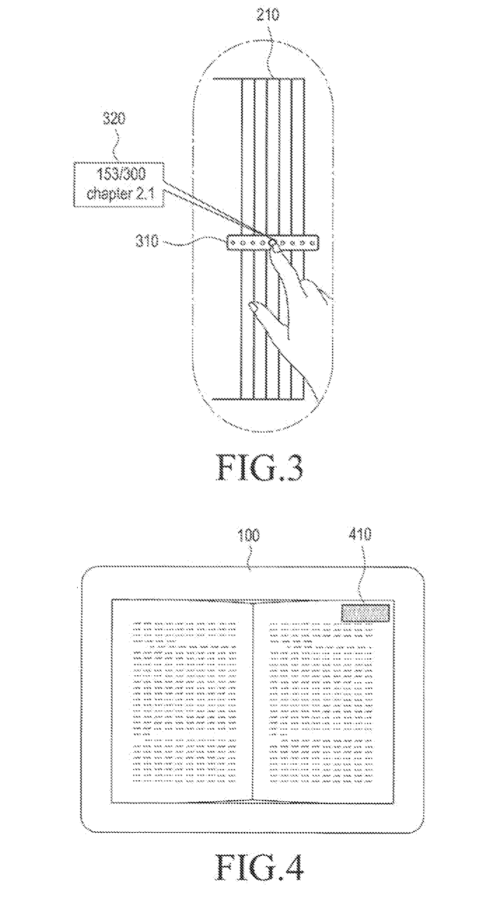

The controller 140 may set up the user input area 210 on one side of the screen. For example, on the display 110, the user input area 210 may be set on a side corresponding to a page section of E-books, similar to that of paper books, as shown in FIG. 2. The user input area 210 may be set on at least one of a top, a bottom, a left and a right side depending on the page section on the display 110. The user input area 210 may include multiple connecting lines that connect the top and the bottom of the display 110 as shown in FIG. 2 to provide a look and feel similar to that of paper books. The user input area 210 may include as many connecting lines as the number of pages (e.g., or the number corresponding to the number of pages) the user has not read yet, or has already read, among the total number of pages displayed on the display 110. The controller 140 may allow the user to set the user input area 210. In other words, the user input area 210 may be changed to an arbitrary area and set in an arbitrary form by user's manipulations on the display 110. The user input area 210 may be formed to partially overlap a page section displayed on the display 110. For example, the controller 140 may set a user input area 410 that overlaps a page section as shown in FIG. 4, depending on the user's action.

Accordingly, the E-book terminal 100 according to an embodiment of the present disclosure may provide a look and feel of traditional paper books to the user as it allows the user to switch pages in the user input area 210.

The controller 140 may set up a zoomed area (or a detailed page area) obtained by zooming the user input area 210 to provide a user interface by which the user may easily switch a screen. Detailed page information represents information about the page displayed on the display 110, and may include the total number of pages, a number of the page the user has selected, and chapter information of the page the user has selected. For example, the controller 140 may set a zoomed area 310 and detailed page information 320, as shown in FIG. 3.

The controller 140 receives action commands from the input recognizer 130. In other words, the controller 140 may receive, from the input recognizer 130, an action command including at least one of a moving start command, a page moving command, a moving stop command, an option search command, and an option selection command.

Upon receiving a moving start command from the input recognizer 130, the controller 140 detects a start page based on the page displayed on the display 110. The start page may be a page being displayed on the display 110.

Upon receiving a page moving command and a moving stop command from the input recognizer 130, the controller 140 detects a moving direction based on the moving start command, the page moving command and the moving stop command. In other words, the controller 140 may detect a moving direction by checking a drag action direction based on the page moving command. The controller 140 may check a drag start point based on the moving start command, check a drag end point based on the moving stop command, and detect a moving direction based on the drag start point and the drag end point.

The controller 140 detects a moving distance based on the moving start command, the page moving command, and the moving stop command. In other words, the controller 140 may detect a moving distance by checking a drag action distance based on the page moving command. The controller 140 may detect a moving distance by checking a drag start point based on the moving start command, checking a drag end point based on the moving stop command, and calculating a moving distance based on the drag start point and the drag end point.

The controller 140 sets a page-switching screen to the target page. In other words, the controller 140 recognizes a target page based on the moving direction and the moving distance, and sets a page-switching screen for moving from the start page to the recognized target page. The page-switching screen represents a screen where pages between the start page and the target page are switched. The controller 140 sets a page-switching screen including at least one of an index, summary information, chapter information, headline information, and a representative picture corresponding to each page being switched.

When displaying the page-switching screen, the controller 140 may adjust a transparency of the pages being switched depending on a specified criterion. The specified criterion is one based on which the user or the manager of the E-book terminal 100 may adjust the transparency of the pages. The controller 140 may adjust the transparency of the pages being switched, depending on the number of pages being switched or the number of the content constituting the pages. In other words, the controller 140 may adjust downwardly the transparency of pages being switched, when the number of pages being switched or the number of the content constituting the pages is relatively large.

If there is multiple content, the controller 140 sets a page-switching screen including only the content that meets a specified priority from among the multiple content. The priority may be set by the user or the manager of the E-book terminal 100. The controller 140 may set as a priority, at least one of an index, summary information, chapter information, headline information, and representative information. Conversely, the controller 140 may set as a priority, at least one of a different index, summary information, chapter information, headline information, and representative information for different pages.

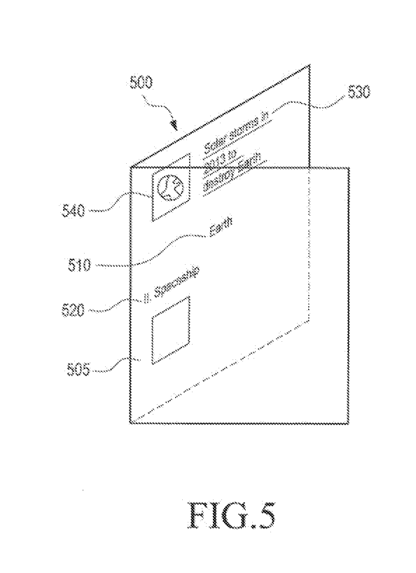

For example, as shown in FIG. 5, the controller 140 may adjust the transparency of a page 505 being switched, depending on a specified criterion, and may set a page-switching screen 500 that includes an index 510, chapter information 520, headline information 530, and a representative picture 540 depending on the priority.

Upon receiving an option search command from the input recognizer 130, the controller 140 controls the display 110 to display user-selectable options in the user input area 210. The selectable options may include at least one of moving between main pages, moving between bookmarked pages, moving between noted pages, moving between pages including searched content, and moving between option-integrated pages. The selectable options may be set by either the user or the manager.

Upon receiving the option selection command from the input recognizer 130, the controller 140 controls the moving of pages based on a specified option selected by the user. Upon receiving a multi-page moving command from the input recognizer 130, the controller 140 controls page moving as much as the specified number of pages at once. The predetermined number of pages may be set by the user or the manager, and represents the number of pages to be moved or switched at once.

The storage 150 stores various programs for controlling the overall operation of the E-book terminal 100. The storage 150 stores data needed by the components of the E-book terminal 100 and data generated by the E-book terminal 100. For example, the storage 150 may store E-books including multiple pages. The storage 150 may store data of the user input area 210 set by the user's manipulation. The storage 150 may also store options which are selectable based on the option selection command.

The storage 150 may provide data upon request of the display 110, the touch screen 120, the input recognizer 130, and the controller 140. The storage 150 may include an integrated memory, or may include multiple memories. For example, the storage 150 may include a Read Only Memory (ROM), a Random Access Memory (RAM), a flash memory, and the like.

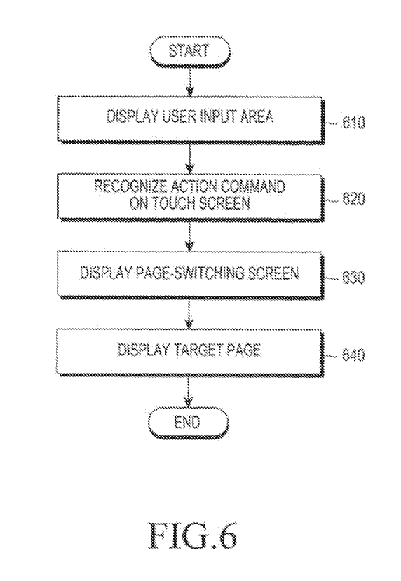

FIG. 6 illustrates an example method of switching a screen according to an embodiment of the present disclosure. It will be apparent to those of ordinary skill in the art that components of an E-book server provided by an embodiment of the present disclosure and described above with reference to FIG. 1 may be integrated or subdivided, so the components performing the functions described herein may be components of the E-book terminal 100 provided by an embodiment of the present disclosure, without being limited as shown above. Therefore, in a description of the screen switching method of the E-book terminal 100, an entity performing each step will be assumed to be the E-book terminal 100, rather than its associated component.

Referring to FIG. 6, the E-book terminal 100 equipped with the touch screen 120 displays the user input area 210 set to support an application for screen switching, in step 610. In other words, the E-book terminal 100 may display the user input area 210 on one side of an E-book displayed on the display 110, or may display the user input area 210 whose form and area are set by the user.

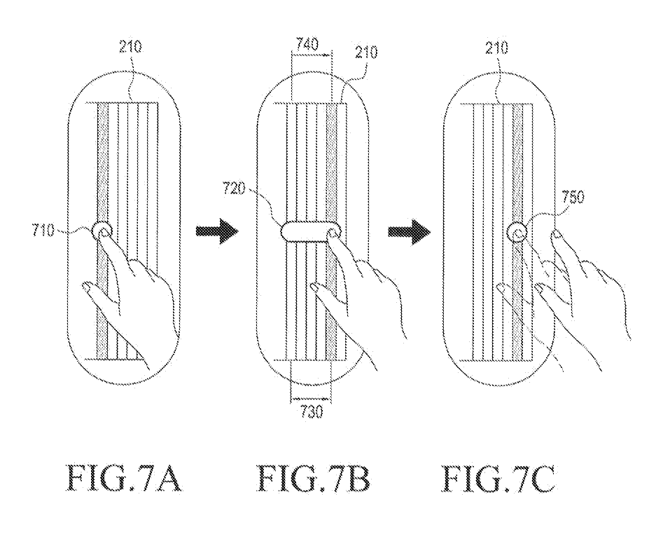

In step 620, the E-book terminal 100 recognizes an action command corresponding to a user's manipulation on the touch screen 120 in the user input area 210. In other words, the E-book terminal 100 recognizes a moving start command corresponding to a press action with a specified pressure in a specified point on the touch screen 120. For example, the E-book terminal 100 may recognize a moving start command by recognizing a press action with a specific pressure in a specified point 710 in the user input area 210 as shown in FIG. 7A. In addition, the E-book terminal 100 recognizes a page moving command corresponding to a drag action made by a specified moving distance with a specified pressure starting from a point where the press action occurred on the touch screen 120. For example, the E-book terminal 100 may recognize a page moving command by recognizing a drag action 720 made by a moving distance 730 starting from a point 710 where the press action occurred in the user input area 210, as shown in FIG. 7B. The E-book terminal 100 recognizes a moving stop command corresponding to a removal of the press action in an arbitrary position during the drag action on the touch screen 120. For example, the E-book terminal 100 may recognize a moving stop command by recognizing a removal of the press action in an arbitrary position 750, as shown in FIG. 7C.

In step 630, the E-book terminal 100 detects a start page, a moving direction, and a moving distance based on the recognized action command, and displays a page-switching screen from the start page to a target page determined based on the moving direction and the moving distance. In other words, the E-book terminal 100 detects a start page based on the moving start command, and detects a moving distance, and a moving direction based on the page moving command. For example, the E-book terminal 100 may detect a moving distance 730 and a moving direction 740 based on a page moving command when a drag action is performed as shown in FIG. 7C. The E-book terminal 100 detects a target page based on the moving stop command. In addition, the E-book terminal 100 checks a target page determined based on the moving distance in the moving direction from the start page, and displays a page-switching screen for switching from the start page to the target page.

In step 640, the E-book terminal 100 displays the target page upon completion of moving from the start page to the target page.

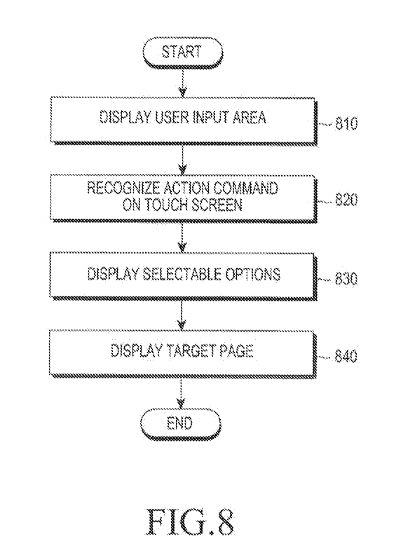

FIG. 8 illustrates an example method of switching a screen according to another embodiment of the present disclosure.

Referring to FIG. 8, the E-book terminal 100 displays the user input area 210 set to receive a page switching input from the user, in step 810.

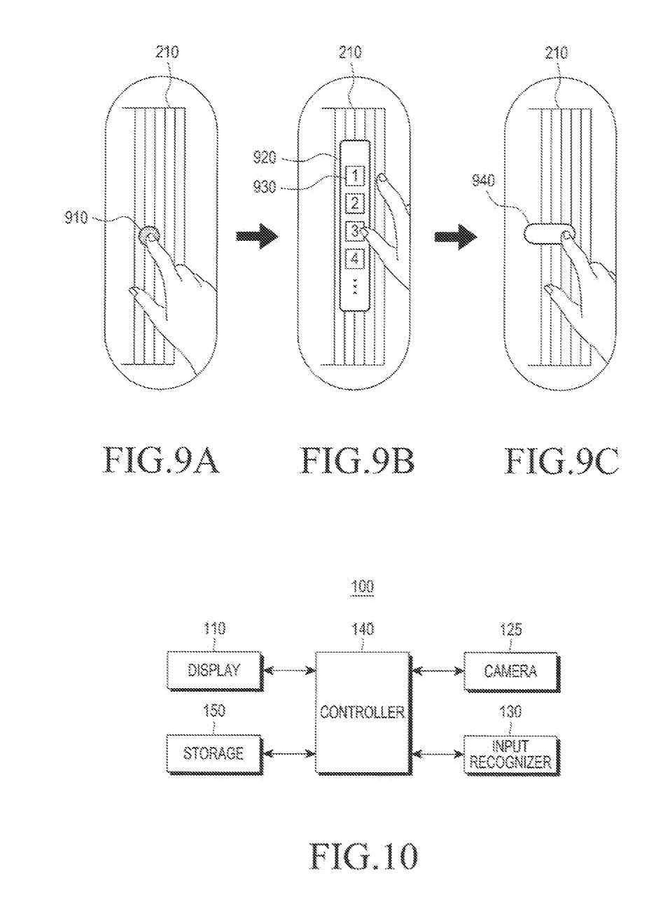

In step 820, the E-book terminal 100 recognizes an action command corresponding to a user's manipulation on the touch screen 120 in the user input area 210. In other words, the E-book terminal 100 recognizes an option search command corresponding to an action in which a press action with a specified pressure is maintained in an arbitrary position for a specified time. For example, the E-book terminal 100 may recognize an action in which the press action is maintained in an arbitrary position 910 for a specified time as shown in FIG. 9A, and recognize an option search command corresponding to the recognition results.

In step 830, the E-book terminal 100 displays user-selectable options corresponding to the option search command in response to the recognition of the option search command. In this case, the E-book terminal 100 may vertically display the user-selectable options in the point where the press action occurred. The selectable options may includes at least one of moving between main pages, moving between bookmarked pages, moving between noted pages, moving between pages including searched content, and moving between option-integrated pages. For example, the E-book terminal 100 may vertically display user-selectable options 920 in the user input area 210 as shown in FIG. 9B at the point 910 where the press occurred as shown in FIG. 9A. In this case, the E-book terminal 100 may set the selectable options as shown in FIG. 9B by defining a number ‘1’ as moving between bookmarked pages, a number ‘2’ as moving between noted pages, a number ‘3’ as moving between pages including searched content, and a number ‘4’ as moving between main pages.

The E-book terminal 100 recognizes an option selection command corresponding to an upward/downward drag action. For example, the E-book terminal 100 may select the number ‘1’ 930 from among the user-selectable options as shown in FIG. 9B. The E-book terminal 100 may recognize an option selection command corresponding to the number ‘1’ 930, which is an option selected by the user.

Thereafter, the E-book terminal 100 may recognize a page moving command by recognizing a drag action 940 in the user input area 210 as shown in FIG. 9C.

In other words, in the E-book terminal 100 provided by an embodiment of the present disclosure, as shown in FIGS. 9A to 9C, a horizontal drag action may be made to move pages and a vertical drag action may be made to select an option. Accordingly, the user may perform moving between pages by manipulating the proposed E-book terminal 100.

In step 840, the E-book terminal 100 displays a page-switching screen for moving or switching from the start page to the target page, and displaying the target page upon completion of moving from the start page to the target page. Specifically, the E-book terminal 100 detects the start page based on the displayed page, and checks an option selection command recognized by the user. For example, the E-book terminal 100 may check moving between bookmarked pages based on the option selection command. The E-book terminal 100 may detect a moving direction based on a page moving command, and check a target page corresponding to the page that is bookmarked in the moving direction. The E-book terminal 100 displays the page-switching screen for moving from the start page to the target page, and displays the target page.

FIG. 10 illustrates an example E-book terminal according to another embodiment of the present disclosure.

Referring to FIG. 10, an E-book terminal 100 includes a display 110, a camera 125, an input recognizer 130, a controller 140, and a storage 150.

The display 110 displays E-books including multiple pages. The display 110 displays a page-switching screen on which page switching is performed depending on an action command corresponding to the movement of a user's finger, which is captured and detected by the camera 125. The display 110 displays a target page based on an action command.

The display 110 may also display the movement captured by the camera 125.

The camera 125 captures the movement of a user's finger by processing captured frames. The camera 125 provides the processed captured frames to the input recognizer 130. The camera 125 processes image/video frames which are captured by an image sensor in a frame acquisition mode. The processed image/video frames may be displayed on the display 110. Depending on its configuration, the E-book terminal 100 may have two or more cameras.

The input recognizer 130 recognizes an action command corresponding to the movement of a user's finger, which is captured by the camera 125. In other words, the input recognizer 130 recognizes an action command including at least one of a page moving command, an option search command, and an option selection command based on the image/video frames captured and processed by the camera 125. Motions unique to action commands may be set by the user or the manager. The input recognizer 130 may recognize an action command by comparing stored frames with captured frames processed by the camera 125. The input recognizer 130 provides the recognized action commands to the controller 140.

The controller 140 controls components of the E-book terminal 100 to switch content including a plurality of pages. In other words, the controller 140 receives, from the input recognizer 130, an action command including at least one of a page moving command, an option search command, and an option selection command. The controller 140 detects a moving direction based on the page moving command. The controller 140 detects a start page based on the page currently displayed on the display 110. The controller 140 performs inter-page moving in the moving direction starting from the start page.

The controller 140 checks a user-selected option based on the option selection command, sets a page-switching screen for moving between the start page and the page corresponding to the user-selected option, and controls the display 110 to display the target page upon completion of page moving.

The storage 150 stores various programs that may be executed for controlling the overall operation of the E-book terminal 100. The storage 150 stores the data generated or needed by the display 110, the camera 125, the input recognizer 130 and the controller 140, which are components of the E-book terminal 100. For example, the storage 150 may store action commands corresponding to movements of the user's finger. The storage 150 may store E-books including a plurality of pages. The storage 150 may also store image frames processed by the camera 125.

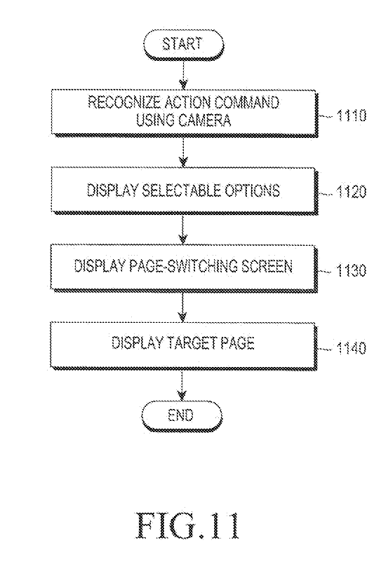

FIG. 11 illustrates an example method of switching a screen according to another embodiment of the present disclosure.

Referring to FIG. 11, the E-book terminal 100 recognizes an action command corresponding to movement of a user's finger, which is captured by the camera 125, in step 1110. In other words, the user performs a motion corresponding to an option search command, and the E-book terminal 100 recognizes the option search command corresponding to the movement of the user' s finger, which is captured by the camera 125.

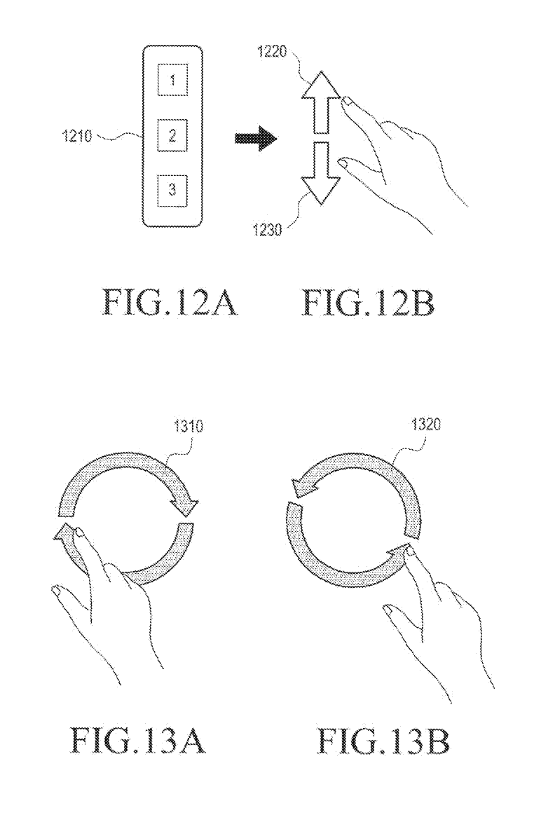

In step 1120, the E-book terminal 100 displays user-selectable options in response to the recognized option search command. For example, the E-book terminal 100 may display user-selectable options 1210 as shown in FIG. 12A. The E-book terminal 100 recognizes an option selection command corresponding to the user's movement. For example, as shown in FIG. 12B, the E-book terminal 100 increases an option selection number one at a time if the user vertically moves up his/her finger as shown by reference numeral 1220, and decreases an option selection number one at a time if the user moves down his/her finger as shown by reference numeral 1230, thereby detecting an option selection command. It will be assumed herein that the user has selected moving between pages including searched content.

The E-book terminal 100 detects a start page based on the page being displayed on the display 110. The E-book terminal 100 detects a page moving command corresponding to the user's movement. For example, the E-book terminal 100 may recognize a page moving command by recognizing movement of a user's finger that moves clockwise as shown in FIG. 13A that may be captured by the camera 125. The E-book terminal 100 may also recognize a page moving command by recognizing movement of a user's finger that moves counterclockwise as shown in FIG. 13B that may be captured by the camera 125.

Thereafter, the E-book terminal 100 detects a moving direction based on the page moving command, and detects a target page given by an option selection command based on the start page. For example, the E-book terminal 100 may detect a target page corresponding to the page including the content that is searched depending on the option selection command. For example, the E-book terminal 100 may increase the page number one at a time in response to the page moving command shown in FIG. 13A, and may decrease the page number one at a time in response to the page moving command shown in FIG. 13B.

In step 1130, the E-book terminal 100 displays a page-switching screen from the start page to the target page determined based on the moving direction.

In step 1140, the E-book terminal 100 displays the target page upon completion of moving the page.

As is apparent from the foregoing description, the proposed E-book terminal and screen switching method may support a user interface similar to traditional paper books for page switching, thus making it possible for the user to have the look and feel of paper books. In addition, the E-book terminal and screen switching method may support an integrated user interface, so the user may easily perform inter-page moving or switching.

Moreover, the proposed E-book terminal and screen switching method may display content depending on its priority from among a plurality of content formed in a plurality of pages, making it possible for the user to take a look at the context between pages.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. An electronic book (E-book) terminal comprising a touch screen and configured to switch displayed content including a plurality of pages, the E-book terminal comprising:
a display configured to display a user input area that supports an application for screen switching, and display the content where page switching is performed depending on a manipulation of the user input area;
an input recognizer configured to recognize an action command corresponding to the manipulation made of the touch screen in the user input area displayed on the display; and
a controller configured to:
detect a start page, a moving direction and a moving distance based on the action command recognized by the input recognizer;
display, on the display, a page-switching screen from the start page to a target page determined based on the moving direction and the moving distance; and
display the target page upon completion of the moved page.

2. The E-book terminal of claim 1, wherein the input recognizer is configured to:
recognize the action command by recognizing a page moving start command corresponding to a press with a specified pressure and in a specific point on the touch screen;
recognize a page moving command corresponding to a drag action by a specified moving distance and with a specified pressure starting from a point where the press action occurred; and
recognize a moving stop command corresponding to a removal of a press action with a specific pressure in an arbitrary position during the drag action,
wherein optionally, the input recognizer is configured to recognize the action command further by recognizing an option search command corresponding to an action in which a press action with a specified pressure is maintained in an arbitrary position during the drag action for a predetermined time, and an option selection command corresponding to a drag action performed upwards or downwards after the option search command is recognized.

3. The E-book terminal of claim 2, wherein the display is configured to vertically display one or more user-selectable options in a position where the press action occurred for input of the option search command under control of the controller in response to the recognition of the option search command recognized by the input recognizer.

4. The E-book terminal of claim 3, wherein when the input recognizer is configured to recognize the page moving command after a specified option is selected depending on the option selection command, the controller being configured to control page moving corresponding to the recognized page moving command depending on the selected specified option.

5. The E-book terminal of claim 4, wherein the display is configured to display at least one of an index, summary information, chapter information, headline information, and a representative picture corresponding to each page being switched when displaying the page-switching screen under control of the controller in response to the page moving command recognized by the input recognizer.

6. The E-book terminal of claim 5, wherein when displaying the page-switching screen, the controller is configured to adjust a transparency of each page being switched, depending on a specified criterion.

7. The E-book terminal of claim 6, wherein when displaying the page-switching screen and when there is a plurality of content, the controller is configured to control the display to display content that meets a specified priority from among the plurality of content.

8. The E-book terminal of claim 1, wherein the controller is configured to change the user input area to an arbitrary area and set up in an arbitrary form on a screen constituting the display based on the manipulation.

9. The E-book terminal of claim 2, wherein the option selectable based on the option selection command includes at least one of moving between main pages, moving between bookmarked pages, moving between noted pages, moving between pages including searched content, and moving between option-integrated pages.

10. The E-book terminal of claim 1, wherein the input recognizer is configured to recognize an action command corresponding to movement on the display, which is detected by a camera.

11. A method for switching displayed content including a plurality of pages equipped with a touch screen, the method comprising:
displaying a user input area configured to support an application for screen switching;
recognizing an action command corresponding to a manipulation made on the touch screen in the displayed user input area;
detecting a start page, a moving direction, and a moving distance based on the recognized action command; and
displaying a page-switching screen from the start page to a target page that is determined based on the moving direction and the moving distance; and
displaying the target page upon completion of moving from the start page to the target page.

12. The method of claim 11, wherein the action command includes at least one of a page moving start command corresponding to a press action with a specified pressure in a specified point on the touch screen, a page moving command corresponding to a drag action made by a specified moving distance with a specified pressure starting from a point where the press action occurred, and a moving stop command corresponding to a removal of the press action in an arbitrary position during the drag action; and
wherein optionally, the action command further includes an option search command corresponding to a particular action in which the press action is maintained in an arbitrary position during the drag action for a specified time, and an option selection command corresponding to a drag action made upward or downward after the option search command is recognized.

13. The method of claim 12, further comprising, upon recognition of the option search command, vertically displaying user-selectable options in a position where a press action corresponding to the option search command has occurred, in response to the recognition of the option search command.

14. The method of claim 13, further comprising, upon recognition of an input of the page moving command after a specified option is selected by the user, performing page moving corresponding to the recognized page moving command depending on the selected specified option.

15. The method of claim 14, further comprising, when displaying the page-switching screen in response to the recognized page moving command, displaying at least one of an index, summary information, chapter information, headline information, and a representative picture corresponding to each page being switched.

16. The method of claim 15, further comprising adjusting a transparency of each page being switched, depending on a preset criterion, when displaying the page-switching screen.

17. The method of claim 16, further comprising, when displaying the page-switching screen, displaying content that meets a preset priority from among a plurality of content, when there is a plurality of content.

18. The method of claim 11, wherein the user input area may be changed to an arbitrary area and set up in an arbitrary form on a screen comprising a display based on the manipulation.

19. The method of claim 12, wherein the option that is selectable based on the option selection command includes at least one of moving between main pages, moving between bookmarked pages, moving between noted pages, moving between pages including searched content, and moving between option-integrated pages.

20. The method of claim 11, further comprising recognizing an action command corresponding to movement of a user's finger, which is detected by a camera.
